(19) United States
(12) Patent Application Publication
(10) Pub. No.: US 2026/0003821 A1
(43) Pub. Date: Jan. 1, 2026

(54) DISPATCH FOR A CONFIGURABLE DATA-FLOW COMPUTE ARRAY AND DATA-PARALLEL COMPUTE UNITS

(71) Applicants: ATI TECHNOLOGIES ULC, Markham (CA); XILINX, INC., San Jose, CA (US); ADVANCED MICRO DEVICES, INC., Santa Clara, CA (US)

(72) Inventors: Ahmed Mohammed ElShafiey Mohammed ElTantawy, Woodbridge (CA); Javier Cabezas Rodriguez, Austin, TX (US); Subramaniam Maiyuran, Folsom, CA (US)

(21) Appl. No.: 18/754,873

(22) Filed: Jun. 26, 2024

(51) Int. Cl. G06F 15/80; G06F 9/48

(52) U.S. Cl. CPC G06F 15/8046; G06F 9/4843

(57) ABSTRACT

A command processor dispatches instructions to a processing unit and a systolic array. The command processor receives a packet including instructions for execution on the systolic array. In response to determining that reconfiguration of the systolic array is to be performed in order to process the instructions, the command processor determines whether a previously dispatched packet is executing on the systolic array. The command processor dispatches reconfiguration instructions for execution concurrently with the processing unit executing the previously dispatched packet in response to determining that there is no conflict between the reconfiguration instructions and a current configuration used by the previously dispatched packet. If a conflict exists between the reconfiguration instructions and the current reconfiguration, the command processor waits for an acknowledgment indicating that execution of the previously dispatched packet is complete and dispatches the reconfiguration instructions.

### BACKGROUND

A conventional parallel processing unit includes multiple compute units that independently and concurrently perform operations for instructions received by the parallel processing unit. The compute units each include one or more single-instruction, multiple data (SIMD) units that are programmed to perform the same operation on different data sets to produce one or more results. The parallel processor typically includes a command processor that dispatches instructions for execution by the compute units, e.g., by providing data indicating one or more operations, operands, instructions, variables, register files, or any combination thereof to the compute units. Since each compute unit is programmed to operate independent of the others, parallel processors are often used for computations that can be broken down into multiple independent threads that are dispatched to different compute units. For example, in a graphics pipeline on a graphics processing unit (GPU), each of the compute units is programmed to implement a vertex shader so that the graphics pipeline can concurrently process multiple vertices of a polygon mesh model of a scene. In some cases, the compute units are implemented in multiple (e.g., two) shader engines, and the command processor supports multiple (e.g., four) pipelines that process instructions received from associated queues. For example, the command processor dispatches instructions from the currently active queue for each pipeline to be executed by a subset of the compute units in the shader engines.

A systolic array is typically a data flow circuit architecture that interconnects compute units with a network that allows data to flow between the compute units. Systolic arrays can execute arbitrary programs including matrix operations when the compute units are interconnected as a matrix of rows and columns. To perform an operation, a kernel is used to configure the nodes to compute partial results by applying the kernel to data received by the node. Data is fetched into the systolic array from global memory according to information in one or more buffer descriptors. For example, if the systolic array is configured to perform a matrix multiplication, the buffer descriptors can indicate memory locations of submatrices, the stride of a memory transfer, a block size, and the like. Each node computes a partial result, stores the result within itself, and passes it downstream. Stream switches are configured to route packets between nodes based on identifiers of packets that convey data between the nodes. For example, stream switches in the systolic array can control whether a node receives data from neighboring nodes to the “north,” “south,” “east,” or “west” and provides partial results to neighboring nodes to the “north,” “south,” “east,” or “west.” Neighbors that provide data to a node are referred to as “upstream” neighbors and neighbors that receive data from a node are referred to as “downstream” neighbors. Nodes can be configured to have more than one upstream or downstream neighbor. The systolic array is reconfigurable to support operations defined by different kernels, different buffer descriptors, or different stream switch configurations. Systolic arrays are often used to perform convolution, correlation, matrix multiplication, or data sorting tasks in artificial intelligence, machine learning, image processing, pattern recognition, computer vision, and deoxyribonucleic acid (DNA) or protein sequence analysis.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system configured to selectively reconfigure nodes of a systolic array concurrently with execution of instructions on a parallel processor, according to some embodiments.

FIG. 3 illustrates an initial state of a controller hierarchy that dispatches instructions to a reconfigurable systolic array and one or more processing units in a processing system, according to some embodiments.

FIG. 4 illustrates the state of the controller hierarchy after a first reconfiguration request has been completed and acknowledged, according to some embodiments.

FIG. 5 illustrates the state of the controller hierarchy after a second reconfiguration request has been completed and acknowledged, according to some embodiments.

FIG. 6 illustrates the state of the controller hierarchy after a third reconfiguration request has been completed and acknowledged, according to some embodiments.

FIG. 7 illustrates the state of the controller hierarchy after execution of an instruction has ended, according to some embodiments.

FIG. 8 illustrates the state of the controller hierarchy after a pipeline queue has disconnected, according to some embodiments.

FIG. 9 illustrates the state of the controller hierarchy after execution of another instruction has ended, according to some embodiments.

FIG. 10 illustrates the state of the controller hierarchy after dispatch of an instruction has ended, according to some embodiments.

FIG. 11 illustrates the state of the controller hierarchy after reconnection of the previously disconnected pipeline queue, according to some embodiments.

FIG. 12 illustrates timing diagrams for different systolic array reconfiguration scenarios, according to some embodiments.

FIG. 13 is a flow diagram of a method of selectively reconfiguring a systolic array in serial with execution of previously dispatched instructions on other processors or concurrently with the execution of the previously dispatched instructions, according to some embodiments.

### DETAILED DESCRIPTION

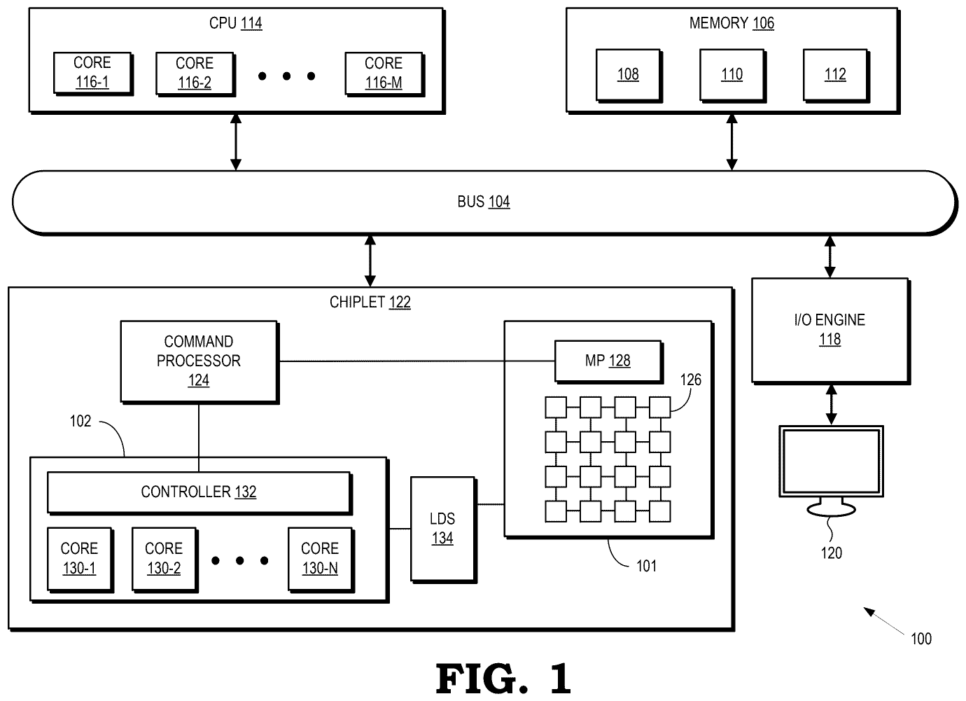

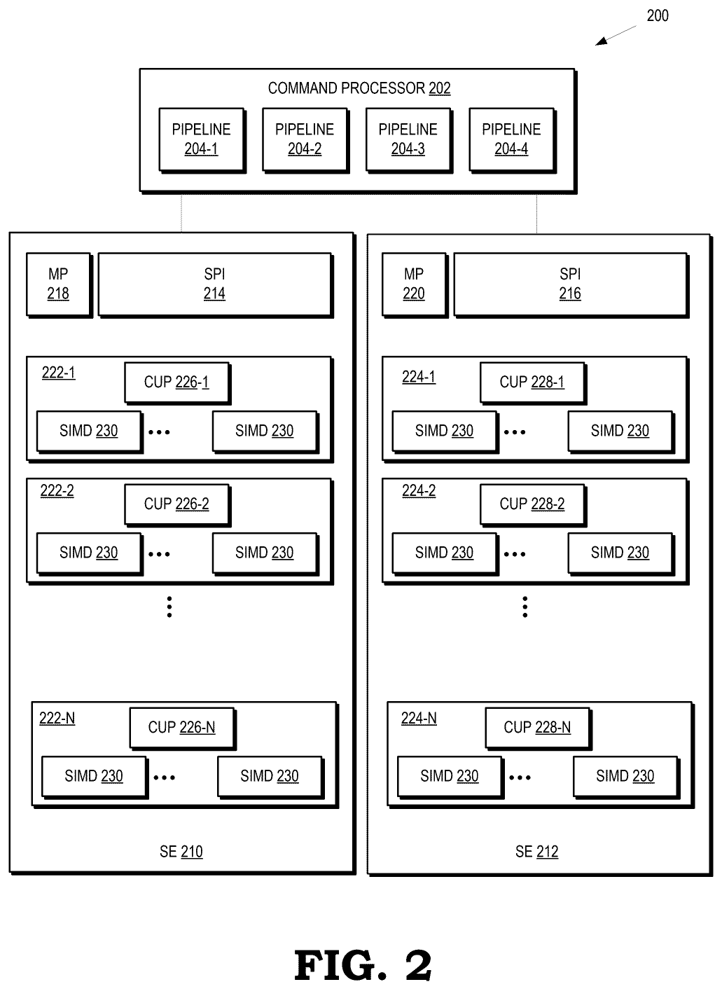

FIGS. 1-13 disclose implementations of systems and methods that integrate a parallel processor such as a GPU, vector processor, neural processing unit, or other processor and a systolic array into a single programming model to leverage their complementary strengths and support data sharing between processes executing on the two types of processor. In this model, a single command processor dispatches streams for the parallel processor and the systolic array. The command processor is also responsible for reconfiguring the systolic array with different kernels, buffer descriptors, or stream switch configurations. The systolic array cannot be reconfigured if the reconfiguration conflicts with a previously dispatched kernel that is executing on the systolic array. For example, a conflict occurs if the reconfiguration requires changing the stream switch configuration used for the previously dispatched kernel. A conflict may not occur if the reconfiguration only requires uploading buffer descriptors and there is an available slot for storing the uploaded buffer descriptors. In the event of a conflict, the reconfiguration of the systolic array must be performed in serial with executing the previously dispatched tasks, and the reconfiguration overhead increases the latency between back-to-back kernels. For example, if the systolic array is executing a first kernel that uses a first stream switch configuration, the systolic array cannot be reconfigured to execute a second kernel that uses a second stream switch configuration until the first kernel is complete.

Although the systolic array cannot be reconfigured when there is a conflict with a previously dispatched instruction, the systolic array can be reconfigured concurrently with the parallel processor executing a previously dispatched instruction. The command processor can therefore reduce the latency of the integrated parallel processor/systolic array by reconfiguring the systolic array concurrently with the parallel processor executing previously dispatched instructions. The command processor inspects packets received from a serial peripheral interface (SPI) and determines whether the reconfiguration of the systolic array is to be performed to process the instructions in the packet. If not, the command processor waits for an acknowledgment from the systolic array that the previously dispatched instructions are complete and then dispatches the reconfiguration instructions from the packet. If the nodes in the systolic array can store multiple sets of boundary descriptors, the processors in the compute unit can fetch new boundary descriptors concurrently with the systolic array executing previously dispatched instructions because this does not give rise to a conflict. If the command processor determines that reconfiguration of the systolic array is to be performed, the command processor determines whether there is a conflict with the previously dispatched packet that is executing on the systolic array. If so, the command processor waits for the acknowledgment from the systolic array before dispatching the reconfiguration instructions from the packet. If there is not a conflict with the previously dispatched packet executing on the systolic array, the command processor dispatches the reconfiguration instructions for execution concurrently with the parallel processor executing the previously dispatched instructions. The command processor then dispatches instructions from the packet in response to acknowledgements indicating that the reconfiguration and execution of the previously dispatched packet are complete.

A hierarchical set of controllers is used to configure, reconfigure, and dispatch instructions to the nodes in the systolic array. The hierarchy includes the command processor to manage streams dispatched to the parallel processors and the systolic arrays, one or more management processors associated with the systolic arrays, and compute unit processors associated with the compute units in the systolic arrays. The management processors receive instructions from the command processor and, in response to receiving the instructions, send reconfiguration commands to nodes and stream switches in corresponding systolic arrays. The instructions can include information indicating a kernel to be executed by a node, buffer descriptors, stream switch configurations, or a combination thereof. The command processor can dispatch instructions and reconfiguration information for multiple pipelines associated with multiple queues of instructions.

FIG. 1 illustrates a processing system 100 configured to selectively reconfigure nodes of a systolic array 101 concurrently with execution of instructions on a parallel processor 102, according to some embodiments. The processing system 100 includes a bus 104 to support communication between entities implemented in the processing system 100. Some implementations of the processing system 100 include other buses, bridges, switches, routers, and the like, which are not shown in FIG. 1 in the interest of clarity. The parallel processor 102 can include, for example, a GPU, a general-purpose GPU (GPGPU), an NPU, or other vector processor or type of parallel processor.

Processing system 100 also includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. Some embodiments of the memory 106 store information representing instructions such as program code 108 for one or more applications (e.g., graphics applications, compute applications, machine-learning applications), data 110 that is consumed by the program code 108 and results 112 produced by executing the program code 108.

Some embodiments of the processing system 100 include a central processing unit (CPU) 114 that is connected to the bus 104 to communicate with other entities in the processing system 100, such as the memory 106. The CPU 114 implements a plurality of processor cores 116-1 to 116-M that execute instructions concurrently or in parallel. In some implementations, one or more of the processor cores 116 operate as SIMD units that perform the same operation on different data sets. Although in the example implementation illustrated in FIG. 1, three processor cores (116-1, 116-2, 116-M) are presented representing an M (where M>=1) number of cores, the number of processor cores 116 implemented in CPU 114 is a matter of design choice. As such, in other implementations, CPU 114 can include any number of processor cores 116. The processor cores 116 are configured to execute instructions such as program code 108 for one or more applications (e.g., graphics applications, compute applications, machine-learning applications) stored in the memory 106. The CPU 114 can consume data 110 and store information in the memory 106 such as the results 112 of the executed instructions.

An input/output (I/O) engine 118 is implemented with circuitry that handles input or output operations associated with display 120, as well as other elements of the processing system 100 such as keyboards, mice, printers, external disks, and the like. The I/O engine 118 is coupled to the bus 104 so that the I/O engine 118 communicates with the systolic array 101, the parallel processor 102, the memory 106, CPU 114, as well as other entities in the processing system 100.

In the illustrated embodiment, the systolic array 101 and the parallel processor 102 are implemented as circuitry on a single substrate such as a chiplet 122. Although a single systolic array 101 and a single parallel processor 102 are depicted in FIG. 1, other embodiments of the processing system 100 implement additional systolic arrays 101 or parallel processors 102 that can be implemented as circuitry on the same substrate or on other substrates such as other chiplets implemented in the processing system 100.

The systolic array 101 includes an array of interconnected nodes 126 (only one node indicated by a reference numeral in the interest of clarity). In the illustrated embodiment, the nodes 126 are implemented as circuitry arranged as a matrix of rows and columns, although other circuit arrangements can be implemented in other embodiments using a set of compute units that are interconnected by a network. The systolic array 101 also includes a management processor 128 that receives instructions and reconfiguration information from the command processor 124. The reconfiguration information can include information representing a kernel, one or more buffer descriptors, and one or more stream switches. The management processor 128 is implemented as circuitry that generates and transmits information to configure the nodes 126 to perform operations such as matrix multiplications.

The configured nodes 126 compute partial results by applying the kernel to data received by the nodes 126. In some embodiments, information is fetched into the nodes 126 of the systolic array 101 from the memory 106 according to information in one or more buffer descriptors. For example, if the systolic array 101 is configured to perform a matrix multiplication, each buffer descriptor can indicate a corresponding memory location of a corresponding submatrix, the stride of a memory transfer, a block size, and the like. Stream switches are implemented as circuitry configured to route packets between nodes 126 based on identifiers of packets that convey data between the nodes 126. Nodes 126 can be configured to have more than one upstream or downstream neighbor. Each node 126 computes a partial result, stores the result within itself, and passes it downstream. The systolic array 101 is reconfigurable to support operations defined by different kernels, different buffer descriptors, or different stream switch configurations.

The parallel processor 102 includes one or more processor cores 130 that each operate as a compute unit configured to perform one or more operations based on one or more instructions received by the parallel processor 102. The compute units in the processor cores 130 are implemented as circuitry that include one or more single-instruction, multiple data (SIMD) units that perform the same operation on different data sets to produce one or more results. The parallel processor 102 includes a controller 132 that includes circuitry configured to provide, to one or more of the processor cores 130, information indicating one or more operations, operands, instructions, variables, register files, or any combination thereof necessary for, helpful for, or aiding in the execution of instructions by the compute units in the processor cores 130.

A command processor 124 communicates with the systolic array 101 and the parallel processor 102. The command processor 124 is implemented as circuitry on one or more substrates such as the chiplet 122. The command processor 124 receives packets including instructions for execution on the systolic array 101, the parallel processor 102, or a combination thereof. The command processor 124 inspects the received packets to identify the instructions and determine their dispatch destination: the systolic array 101, the parallel processor 102, or both. For example, instructions in a packet may be used to perform a set of instructions using both the systolic array 101 and the parallel processor 102. As used herein, the term “herd” refers to a collection of instructions that execute on the systolic array 101, the parallel processor 102, or a combination thereof. Instructions in a herd share memory space in a load data store (LDS) 134 to support efficient data sharing and fusion between instructions executing concurrently on the systolic array 101 and the parallel processor 102. In some embodiments, packets for different streams are received in requests from parallel pipelines. Each stream can include a mix of command packets that are executed on the systolic array 101, the parallel processor 102, or a combination thereof.

Inspection of the packets also allows the command processor 124 to determine whether the systolic array 101 is to be to be reconfigured to execute the instructions in the packet. Some embodiments of the command processor 124 determine that the systolic array 101 was configured in a first configuration associated with a previous set of instructions but the instructions in the newly received and inspected packet require a second configuration. As discussed herein, a configuration of the systolic array 101 is specified by a kernel, one or more buffer descriptors, one or more stream switches, or other parameters. For example, the command processor 124 can inspect instructions in a newly received packet and determine that these instructions require execution of a different kernel than the kernel used by the previous set of instructions. The command processor 124 therefore determines that the systolic array is to be reconfigured with the new kernel before executing the instructions in the newly received packet. Similarly, the command processor 124 can determine that the instructions in the newly received packet require different stream switches, buffer descriptors, or other parameters than those used by the previous set of instructions.

The systolic array 101 cannot be reconfigured concurrently with the systolic array 101 executing a previously dispatched instruction if there is a conflict between the previous configuration and the new configuration. In some embodiments, a conflict occurs if the kernel or stream switches used by instructions in the newly received packet differ from the kernel and stream switches used by the previously dispatched instruction. A conflict may not occur if the buffer descriptors used by the new instructions are different than the buffer descriptors used by the previously dispatched instruction. For example, the systolic array may include multiple slots to store different buffer descriptors. Thus, the new buffer descriptors can be stored in an available slot concurrently with the previously dispatched instruction executing using buffer descriptors in a different slot.

The command processor 124 determines whether a reconfiguration of the systolic array 101 conflicts with the configuration for a previously dispatched packet that is executing on the systolic array 101. If so, the command processor 124 does not dispatch a reconfiguration request or reconfiguration instructions until it receives an acknowledgment from the systolic array 101 indicating that execution of the previously dispatched instructions is complete. If the command processor 124 determines that no conflict exists at the systolic array 101 or that the previously dispatched packet is only executing on the parallel processor 102, the command processor 124 dispatches reconfiguration instructions to the systolic array 101 so that the reconfiguration is performed concurrently with the systolic array 101 or the parallel processor 102 executing the previously dispatched instructions. The command processor 124 then dispatches the herd including instructions from the packet in response to acknowledgements indicating that the reconfiguration and execution of the previously dispatched packet are complete.

In the illustrated embodiment, the command processor 124, the management processor 128, and the controller 132 form a portion of a hierarchical set of controllers that is used to configure, reconfigure, and dispatch instructions (or herds) to the systolic array 101 and the parallel processor 102. The hierarchy also includes compute unit processors associated with the compute units in the systolic array 101. The compute unit processors are not shown in FIG. 1 in the interest of clarity. The management processors 128 receive instructions from the command processor 124 and, in response to receiving the instructions, selectively determine whether to send reconfiguration commands to reconfigure the nodes 126 of the systolic array 101 concurrently with other instructions executing on the systolic array 101 or the parallel processor 102. The reconfiguration instructions can include information indicating a kernel to be executed by a node, buffer descriptors, stream switch configurations, or a combination thereof. Some embodiments of the command processor 124 dispatch instructions and reconfiguration information for multiple pipelines associated with multiple queues of instructions, as discussed herein.

FIG. 2 illustrates a controller hierarchy 200 that is implemented in a processing system such as the processing system 100 shown in FIG. 1, according to some embodiments. The controller hierarchy 200 includes a command processor 202 that communicates with shader engines 210, 212, which are implemented as circuitry on one or more substrates such as the chiplet 122 shown in FIG. 1 Although two shader engines 210, 212 are shown in FIG. 2, other embodiments of the processing system implement more or fewer shader engines. The command processor 202 dispatches instructions and reconfiguration information through a set of pipelines 204. Although the set shown in FIG. 2 includes four pipelines 204, other embodiments of the command processor 202 implement more or fewer pipelines.

The shader engines 210, 212 are implemented using one or more systolic arrays (such as the systolic array 101 shown in FIG. 1) and one or more processing units (such as the parallel processor 102 shown in FIG. 1). The shader engines 210, 212 include corresponding SPIs 214, 216, management processors 218, 220, and compute units 222, 224. Each of the compute units 222, 224 includes a compute unit processor (CUP) 226, 228 that is a part of the controller hierarchy 200. The CUPs 226, 228 receive instructions, operations, commands, data, and reconfiguration information from the corresponding management processor 218, 220. The CUPs 226, 228 use the received information to configure corresponding SIMDs 230 to execute instructions, as discussed herein. The CUPs 226, 228 also provide information to the corresponding management processors 218, 220 such as acknowledgments that the reconfiguration or execution of one or more instructions are complete.

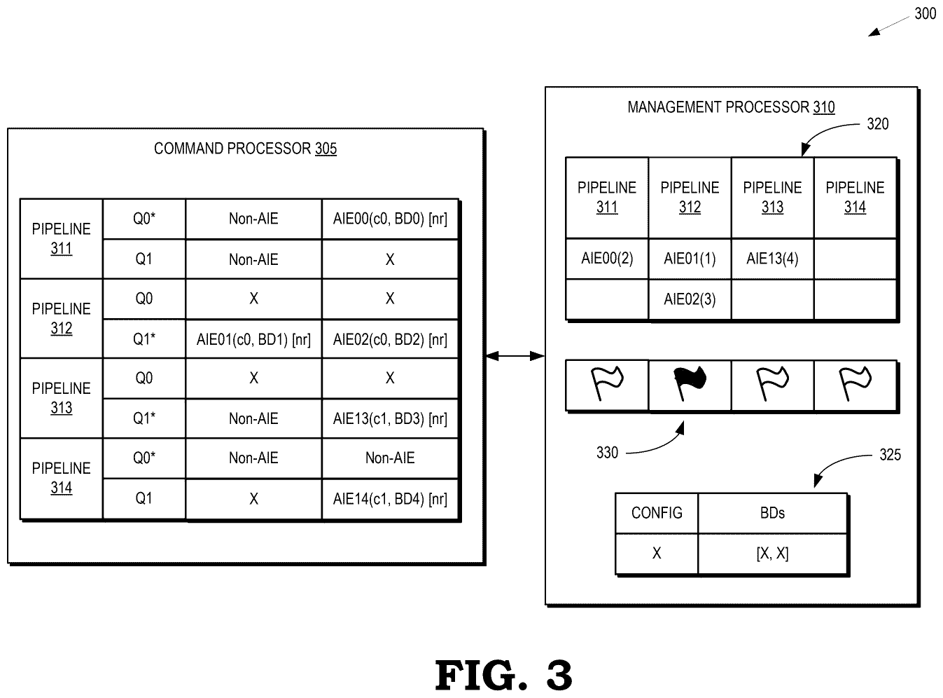

FIGS. 3-11 illustrate states of a controller hierarchy 300 that dispatches instructions to a reconfigurable systolic array and one or more processing units such as a GPU in a processing system, according to some embodiments. The controller hierarchy 300 is implemented in some embodiments of the processing system 100 shown in FIG. 1 or the controller hierarchy 200 shown in FIG. 2. The controller hierarchy 300 includes a command processor 305 and a management processor 310. Although a single management processor 310 is shown in FIG. 3 in the interest of clarity, some embodiments of the controller hierarchy 300 include more than one management processor 310. The command processor 305 dispatches instructions and reconfiguration information to one or more processing units (such as GPUs) and one or more systolic arrays, which are referred to as artificial intelligence engines (AIEs) in some embodiments. The management processor 310 controls the reconfiguration and operation of a corresponding systolic array or AIE, e.g., by sending commands to one or CUPs associated with the compute units.

The command processor 305 inspects received packets and determines whether reconfiguration of one or more systolic arrays is necessary to execute commands in the received packets. If so, the command processor 305 selectively dispatches configuration or reconfiguration instructions/information to reconfigure the systolic array concurrently with instructions executing on a corresponding processing unit or in response to the management processor 310 transmitting an acknowledgment indicating that the systolic array has completed executing previous instructions, as discussed herein. Configuration or reconfiguration commands or instructions can include a code object pointer, a kernel arguments pointer, herd dimensions, a number of herds, or other information. The command processor 305 maintains a set of four pipelines 311, 312, 313, 314, which are collectively referred to herein as “the pipelines 311-314.” However, some embodiments of the command processor 305 maintain more or fewer pipelines. The pipelines 311-314 are associated with corresponding queues. In the illustrated embodiment, each of the pipelines 311-314 is associated with two queues (Q0, Q1), although other embodiments are associated with more or fewer queues.

Initial states of the command processor 305 and the management processor 310 are shown in FIG. 3. The currently active queue in the command processor 305 is indicated by an asterisk. For example, the asterisk indicates that Q0 is active in the pipeline 311. In the illustrated embodiment, each of the queues includes two slots: a first, leftmost, slot includes the currently active operation (i.e., the operation currently being executed) and a second, rightmost, slot includes the next operation scheduled for dispatch from the queue to the systolic array, the processing unit, or a combination thereof. For example, the currently active operation in Q0 on pipeline 311 is a non-artificial-intelligence-engine (non AIE) instruction, i.e., an instruction that does not execute on a systolic array and only executes on a processing unit. The next operation scheduled for dispatch from Q0 in pipeline 311 is an AIE instruction, i.e., an instruction that executes at least partially on a systolic array. The notation “AIE00(c0, BD0) [nr]” indicates that the AIE instruction is instruction 00 and requires the configuration c0 with buffer descriptors BD0. In the illustrated embodiment, the systolic array has not been configured with the configuration c0 to execute instruction AIE00, which is indicated by “[nr]”.

The management processor 310 includes a set 320 of configuration request queues that store information indicating the requested reconfigurations of the systolic array associated with instructions in the dispatch queues at the command processor 305. For example, the configuration request queue for the pipeline 311 includes a request to reconfigure the systolic array to execute the instruction AIE00, which requires the configuration c0 and the buffer descriptors BD0. The number in parenthesis indicates the order in which the configuration requests have been received by the set 320 of configuration request queues. For example, the numbers in parentheses indicate that the configuration requests were received in the order AIE01 at pipeline 312, AIE00 at pipeline 311, AIE02 at pipeline 312, and AIE13 at pipeline 313. A current configuration 325 of the systolic array indicates that it has not yet been configured (X in the config column) and no buffer descriptors are stored in either of the two available slots (X, X). Entries in the valid pipeline list 330 indicate that the pipelines 311, 313, 314 are valid (white flags) because the queued instructions for the pipelines 311, 313, 314 do not require the systolic array. The valid pipeline list 330 indicates that the pipeline 312 is not valid (black flag) because the required configuration c0 and buffer descriptor BD1 for the instruction AIE01 (c0, BD1) have not been loaded into the available slot, as indicated by the suffix [nr] in its entry for Q1 of pipeline 312.

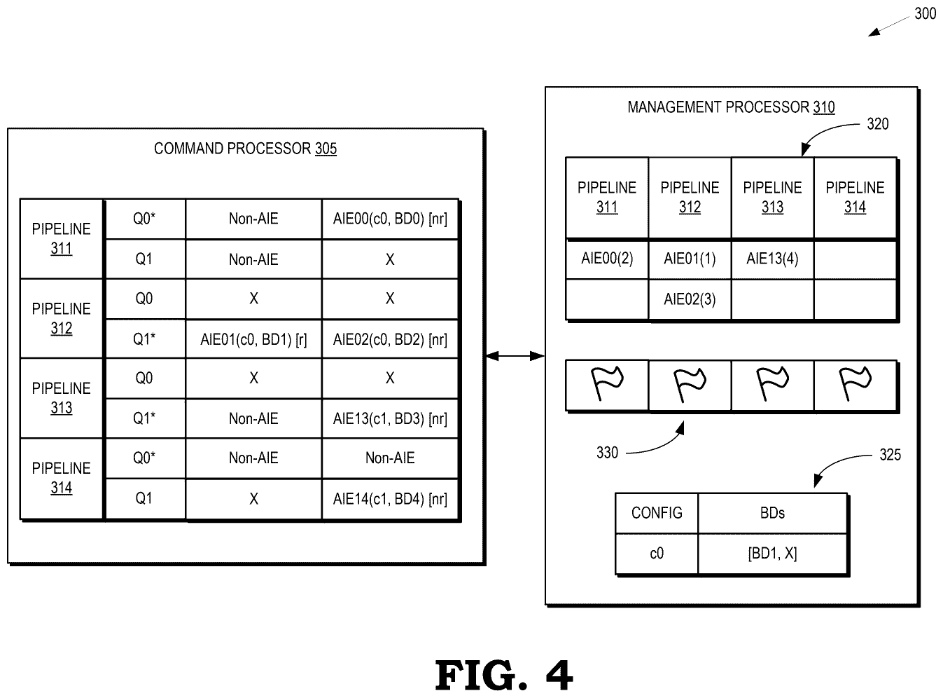

The state of the command processor 305 and the management processor 310 after the configuration request AIE01 has been completed and acknowledged by the CUPs is shown in FIG. 4. In the illustrated embodiment, the management processor 310 has instructed the CUPs to perform configurations including uploading a kernel, configuring the stream switches, and loading the buffer descriptor set BD1, as indicated in the current configuration 325. Once these operations are complete, the CUPs return an acknowledgment to the management processor 310 and the management processor 310 stores information in the valid pipeline list 330 indicating that pipeline 312 is valid (the white flag). The management processor 310 sends an acknowledgment to the command processor 305 and, in response to receiving the acknowledgment, the command processor 305 modifies the current entry in Q1 of pipeline 312 from [nr] to [r] to indicate that the systolic arrays are configured and ready for dispatch and execution of the next instruction.

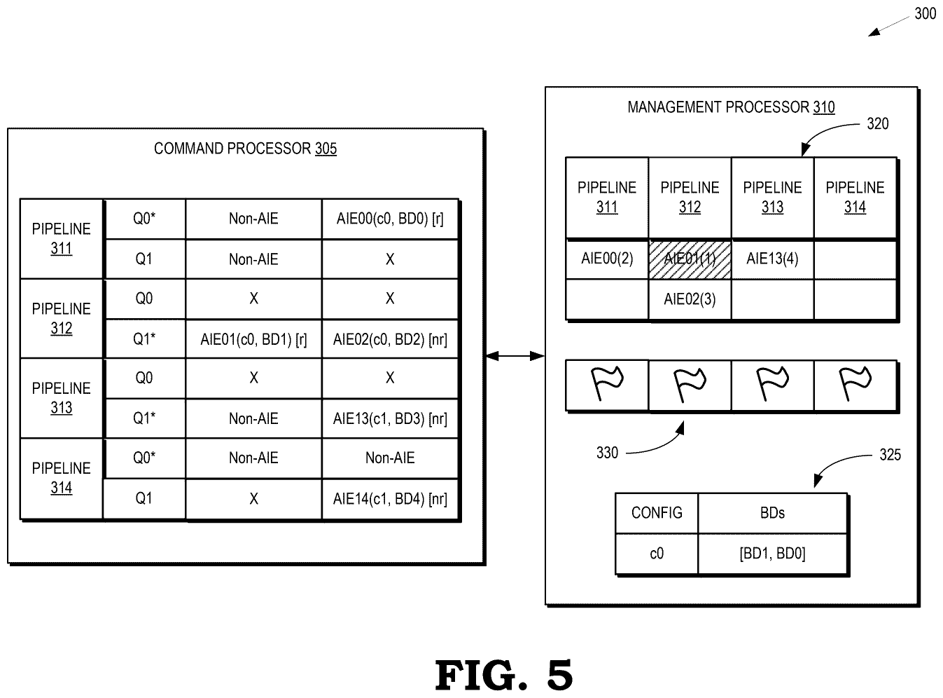

The state of the command processor 305 and the management processor 310 after the configuration request AIE00 has been completed and acknowledged by the CUPs is shown in FIG. 5. The reconfiguration request AIE01 is complete, as indicated by the crosshatched box in the valid pipeline list 330 of pipeline 312. The management processor 310 then selects the reconfiguration request AIE00 for pipeline 311 from the set 320. The instruction AIE00 uses the configuration c0, which is already loaded, as indicated by the current configuration 325. The only change to be performed to execute the instruction AIE00 is loading the set of buffer descriptors BD0. An empty slot is available so the management processor 310 loads the buffer descriptors BD0 and sends an acknowledgment to the command processor 305. The next entry in Q0 of pipeline 311 is modified from [nr] to [r] to indicate that the systolic array is configured and ready for dispatch and execution of the next instruction in the pipeline 311.

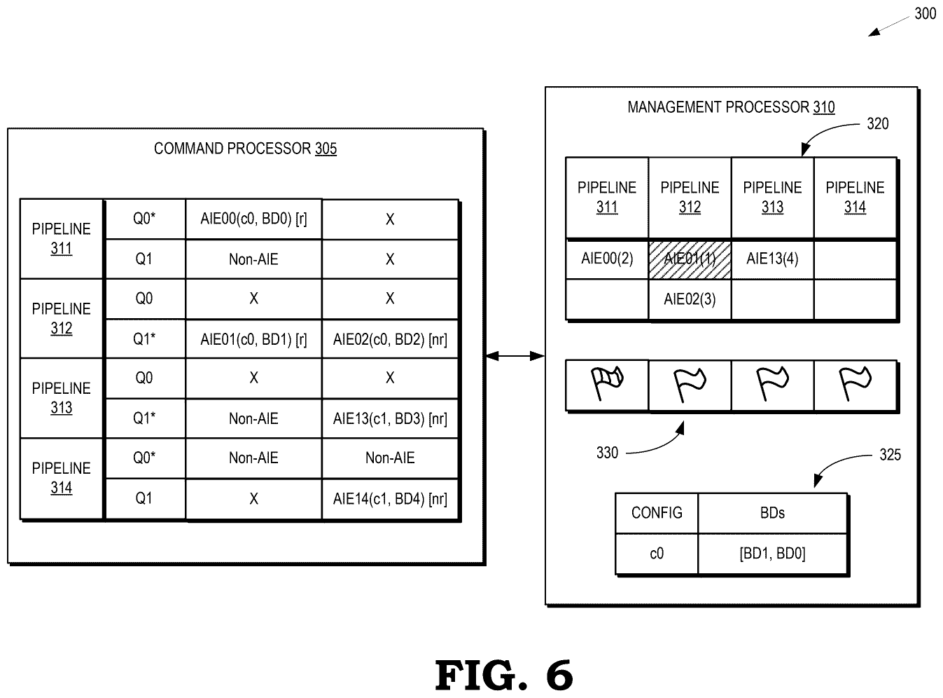

The state of the command processor 305 and the management processor 310 after the non-AIE dispatch from Q0 in pipeline 311 ends and AIE00 becomes the current instruction in pipeline 311 is shown in FIG. 6. The management processor 310 determines that the instruction AIE00 uses the configuration c0 and the buffer descriptors BD0, which are ready to be (or already) loaded, as indicated by the current configuration 325. The current entry in Q0 of pipeline 311 is marked [r] and the pipelines 311-314 are all valid, as indicated by the valid pipeline list 330. However, in the illustrated embodiment there is a resource conflict between the currently executing instruction AIE01 in pipeline 312 and the current instruction AIE00 in the pipeline 311. The SPI therefore waits to dispatch the instruction AIE00 in the pipeline 311 until the instruction AIE01 in pipeline 312 has completed, as indicated by the striped flag in the valid pipeline list 330. In the illustrated embodiment, the management processor 310 also selects the instruction AIE02 because this was the third instruction received, as indicated by (3) in pipeline 312 of the valid pipeline list 330. However, there is no space available to load the new buffer descriptors BD2 so the management processor 310 waits to receive an acknowledgment that space has been freed up by another instruction completing.

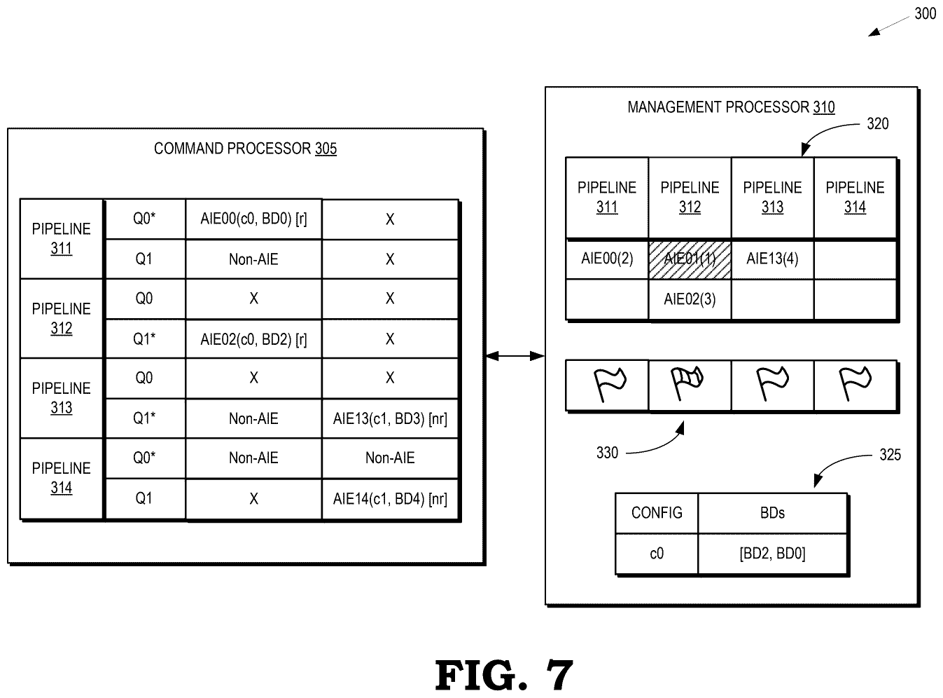

The state of the command processor 305 and the management processor 310 after the dispatch of AIE01 from Q1 in pipeline 312 has ended is shown in FIG. 7. Completion of AIE01 frees space to load the buffer descriptors BD2, which are required by AIE02. The management processor 310 loads the buffer descriptors BD2, as indicated by the current configuration 325, and sends an acknowledgment message to the command processor 305 indicating that reconfiguration is complete for execution of the instruction AIE02. In response to receiving the acknowledgment, the command processor 305 updates the entry for AIE02 in Q1 of pipeline 312 to [r] to indicate that the reconfigured systolic array is ready to execute the instruction AIE02. In the illustrated embodiment, the pipeline 311 has a higher priority than the pipeline 312 due to its longer pendency. The pipeline 311 therefore becomes valid and the (otherwise valid) pipeline 313 is required to wait, as indicated by the striped flag in the valid pipeline list 330.

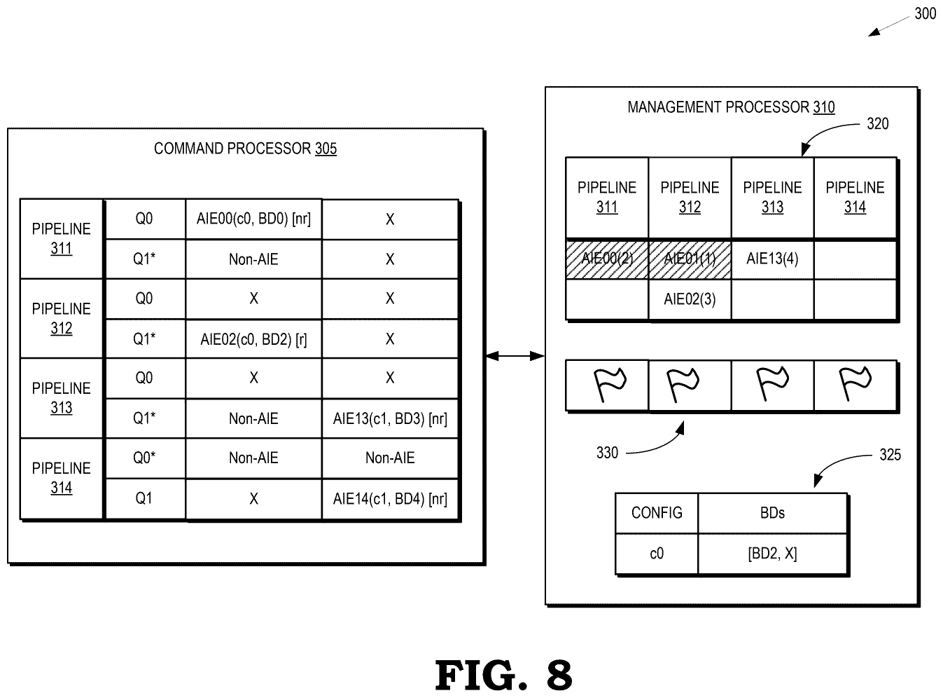

The state of the command processor 305 and the management processor 310 after Q0 disconnects from pipeline 311 during the dispatch of AIE00 is shown in FIG. 8. In response to Q0 disconnecting from pipeline 311, Q1 connects to the pipeline 311, as indicated by the asterisk on Q1 and the [nr] suffix on AIE00 (c0, BD0). At this point, the reconfiguration requests for AIE01 and AIE00 are complete, as indicated by the crosshatched boxes in the valid pipeline list 330 of pipeline 312 and pipeline 311, respectively. The buffer descriptors BD0 are no longer used once Q0 disconnects because the instruction AIE00 is no longer being dispatched to the systolic array. A slot is therefore available to load new buffer descriptors, as indicated in the current configuration 325.

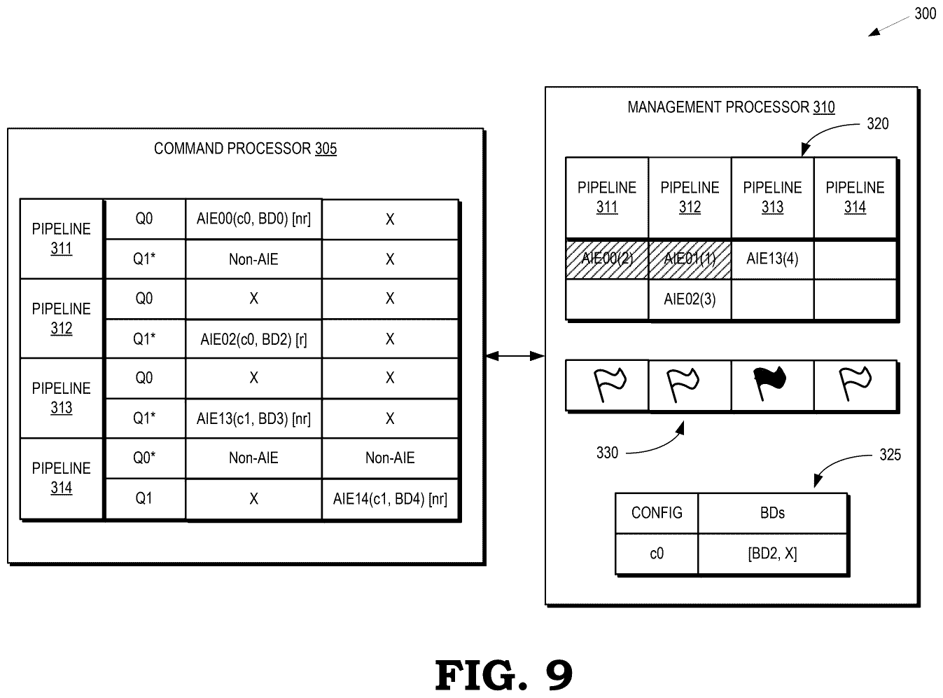

The state of the command processor 305 and the management processor 310 after the non-AIE instruction in Q1 of pipeline 313 ends is shown in FIG. 9. In response to the non-AIE instruction in Q1 of pipeline 313 ending, the command processor 305 moves the instruction AIE13 to the front of the queue (i.e., the current slot) and the management processor 310 determines that reconfiguration of the systolic array to the configuration c1 is necessary to execute the instruction AIE13. However, the previously dispatched instruction AIE02 is still using the previous configuration c0 and so the management processor 310 is unable to reconfigure the systolic array. The pipeline 313 is flagged as not being valid, as indicated by the black flag in the valid pipeline list 330.

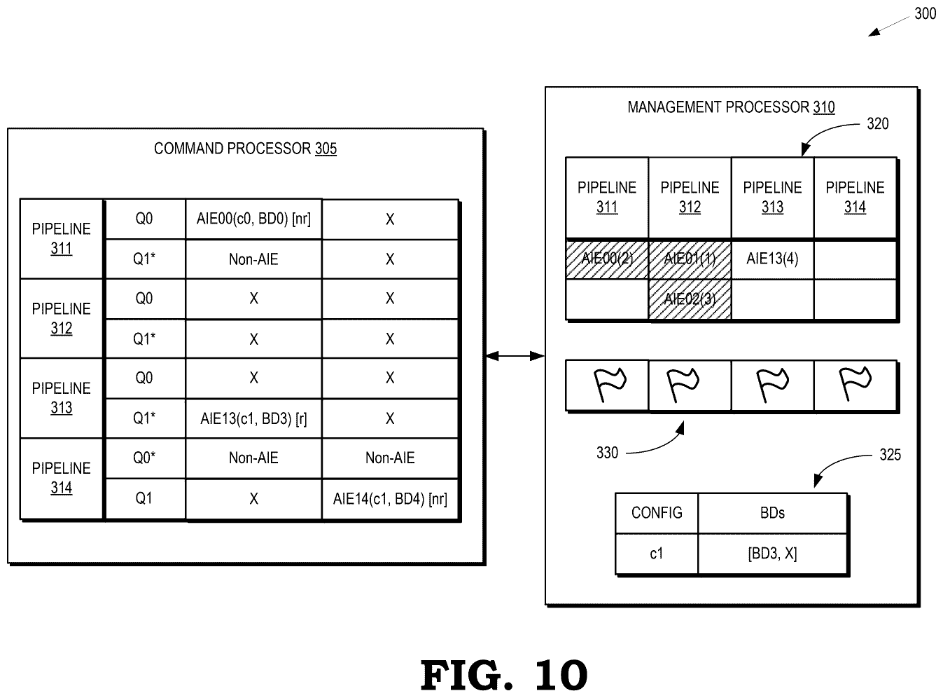

The state of the command processor 305 and the management processor 310 after the dispatch of the instruction AIE02 in pipeline 312 ends is shown in FIG. 10. In response to the ending of the dispatch of the instruction AIE02, the management processor 310 issues a reconfiguration to change the current configuration to the configuration c1 and the buffer descriptors BD3, as indicated in the current configuration 325. In response to receiving an acknowledgment from the management processor 310 that the reconfiguration is complete, the command processor 305 marks the instruction AIE03 as ready, [r].

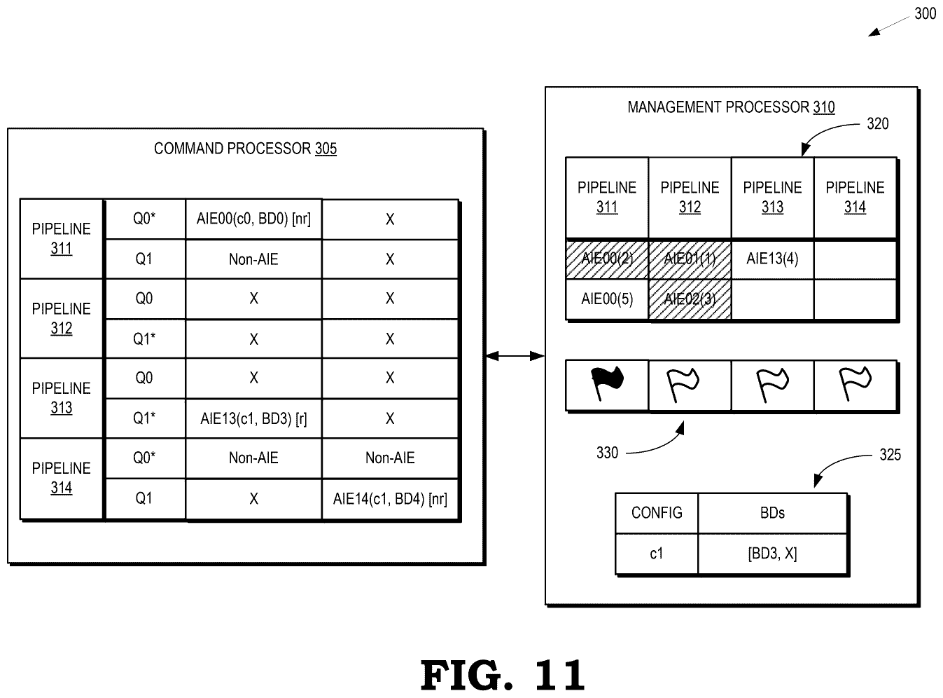

The state of the command processor 305 and the management processor 310 after Q0 reconnects to pipeline 311 is shown in FIG. 11. The command processor 305 reactivates Q0 in pipeline 311 (as indicated by the asterisk) in response to Q0 reconnecting to the pipeline 311. The management processor 310 does not reconfigure the systolic arrays to relaunch AIE00 from Q0 of pipeline 311 because this instruction requires the configuration c0 and the currently executing instruction AIE13 uses the configuration c1. The management processor 310 therefore waits to receive an acknowledgment from the CUPs that the instruction AIE13 has completed before the management processor 310 issues the reconfiguration information for the configuration c0. The pipeline 311 is therefore not valid, as indicated by the black flag in the valid pipelines list 330.

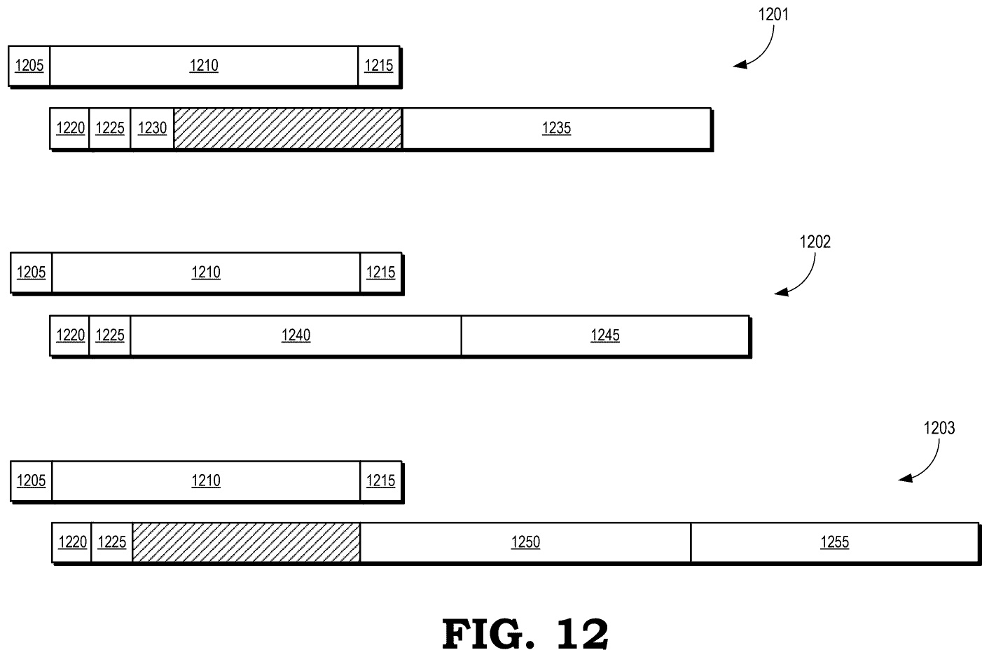

FIG. 12 illustrates timing diagrams 1201, 1202, 1203 for different systolic array reconfiguration scenarios, according to some embodiments. The timing diagrams 1201-1203 illustrate timing used in some embodiments of the processing system 100 shown in FIG. 1 and the controller hierarchy 200 shown in FIG. 2. The upper portion of the timing diagrams 1201-1203 illustrates the timing of activities associated with dispatching a first instruction for execution. The activities include parsing and processing a first packet at the command processor in section 1205, dispatching and executing instructions from the first packet in section 1210, and performing synchronization operations (such as sending acknowledgements) in section 1215.

The timing diagram 1201 illustrates a scenario in which the systolic array is not reconfigured. In that case, the command processor begins parsing and processing of a second packet in section 1220 as soon as parsing and processing of the first packet is complete. The management processor uses information provided by the command processor to determine (in section 1225) whether the systolic array is to be reconfigured to execute instructions from the second packet. In this scenario, reconfiguration is not necessary. However, if any buffer descriptors are to be used and there are slots available, the management processor fetches these buffer descriptors in section 1230. Once the steps are complete, the command processor and management processor wait to receive acknowledgment indicating that the previously dispatched instructions from the first packet are complete. Instructions from the second packet are then dispatched in section 1235. The crosshatched section indicates latency or idle time.

The timing diagram 1202 illustrates a scenario in which the systolic array is reconfigured concurrently with dispatch of instructions to other processing units. The command processor initiates parsing and processing of the second packet in section 1220 as soon as parsing and processing of the first packet is complete. The management processor uses information provided by the command processor to determine (in section 1225) whether the systolic array is to be to be reconfigured to execute instructions from the second packet. In this scenario, reconfiguration is necessary. The command processor also determines that the instructions in the first packet were only dispatched to other processing units and were not dispatched to the systolic array. Thus, reconfiguration (in section 1240) proceeds concurrently with dispatch of the first instructions. The instructions in the second packet are dispatched (in section 1245) in response to receiving an acknowledgment that the reconfiguration is complete.

The timing diagram 1203 illustrates a scenario in which the systolic array cannot be reconfigured concurrently with dispatch of instructions to other processing units, e.g., due to a conflict at the systolic array. The command processor initiates parsing and processing of the second packet in section 1220 as soon as parsing and processing of the first packet is complete. The management processor uses information provided by the command processor to determine (in section 1225) whether the systolic array is to be to be reconfigured to execute instructions from the second packet. In this scenario, reconfiguration is necessary. The command processor also determines that the instructions in the first packet were dispatched to the systolic array and, in some cases, to the other processing units. The command processor detects a conflict between the configurations of the instructions and the different packets. Thus, reconfiguration cannot proceed concurrently with dispatch of the first instructions. The management processor therefore initiates reconfiguration (in section 1250) of the systolic array in response to receiving an acknowledgment that execution of the first instructions in the first packet is complete. The instructions in the second packet are then dispatched (in section 1255) in response to receiving an acknowledgment that the reconfiguration is complete.

Comparison of the timing diagrams 1201-1203 shows that reconfiguration of the systolic array concurrently with executing previously dispatched instructions on other processing units successfully hides some or all the reconfiguration latency. For example, the duration of the timing diagram 1201 (which does not require reconfiguration) is approximately equal to the duration of the timing diagram 1202 that includes concurrent reconfiguration. For another example, the duration of the timing diagram 1202 (with concurrent reconfiguration) has significantly lower latency and shorter duration than the timing diagram 1203, which performs reconfiguration in response to completion of the previously dispatched instructions and does not allow concurrent reconfiguration.

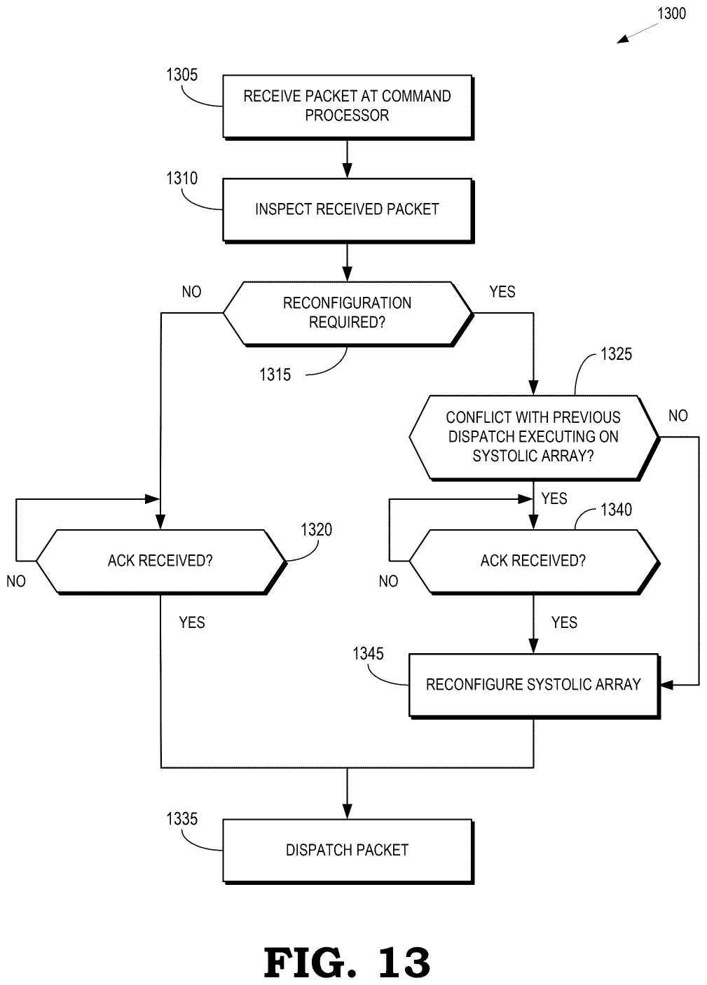

FIG. 13 is a flow diagram of a method 1300 of selectively reconfiguring a systolic array in serial with execution of previously dispatched instructions on other processors or concurrently with the execution of the previously dispatched instructions, according to some embodiments. The method 1300 is implemented in some embodiments of the processing system 100 shown in FIG. 1 or the controller hierarchy 200 shown in FIG. 2.

At block 1305, the command processor receives a packet including instructions for execution on one or more processing units, one or systolic arrays, or a combination thereof. At block 1310, the command processor inspects the received packet to determine the requirements of the instructions in the packet.

At decision block 1315, the command processor decides whether reconfiguration of the systolic array is required to execute one or more of the instructions included in the inspected packet. If not, the method 1300 flows to the decision block 1320. In some embodiments, reconfiguration of the systolic array is not required if the instructions in the packet can be executed using the current configuration such as the current kernel, stream switch configuration, and buffer descriptors. If reconfiguration of the systolic array is required, the method 1300 flows to the block 1325.

At decision block 1320, the command processor and the management processor then wait for an acknowledgement that the currently executing instructions are complete. In response to receiving the acknowledgment, the method 1300 flows to the block 1335.

At block 1325, the management processor determines whether reconfiguration conflicts with the configuration used by the previously dispatched instructions that are executing on the systolic array. If so, reconfiguration of the systolic array cannot be performed concurrently with execution of these instructions. The method 1300 therefore flows to decision block 1340. If no conflict exists, reconfiguration of the systolic array can be performed concurrently with execution of the instructions and the method 1300 flows to the block 1345. As discussed herein, conflicts arise when reconfiguration would change the configuration parameters used by instructions that are currently executing on the systolic array. Conflicts may not occur for reconfigurations that only require updating the buffer descriptors if additional slots are available to load new buffer descriptors that are required by the instructions.

At decision block 1340, the command processor and the management processor wait until an acknowledgment is received that execution of the previously dispatched instructions is complete. In response to receiving the acknowledgment, the method 1300 flows to the block 1345.

At decision block 1345, the management processor issues instructions to reconfigure the systolic array. Once the reconfiguration is complete, the method 1300 flows to the block 1335.

The command processor dispatches instructions from the packet for execution at block 1335.

In some embodiments, the apparatus and techniques described above are implemented in a system including one or more integrated circuit (IC) devices (also referred to as integrated circuit packages or microchips), such as the processing systems described above with reference to FIGS. 1-13. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a command processor that dispatches instructions to a processing unit and a systolic array, a packet comprising instructions for execution on the systolic array; and
in response to determining that a reconfiguration of the systolic array is to be used to process the instructions and in response to no conflict between the reconfiguration and a current configuration of the systolic array used by a previously dispatched packet that is executing on the systolic array, dispatching reconfiguration instructions for execution concurrently with the processing unit executing the previously dispatched packet.

2. The method of claim 1, further comprising:
receiving an acknowledgment from the systolic array indicating that execution of the previously dispatched packet on the systolic array is complete; and
dispatching the reconfiguration instructions for execution on the systolic array in response to receiving the acknowledgment.

3. The method of claim 1, wherein dispatching the reconfiguration instructions comprises dispatching information indicating at least one of an updated kernel for execution on nodes of the systolic array, an updated stream switch configuration indicating routing of packets between the nodes of the systolic array, or an updated buffer descriptor indicating a memory location, a stride, or a block size of information stored in a memory.

4. The method of claim 3, wherein the nodes of the systolic array are configured to store pluralities of buffer descriptors, and the method further comprising:
fetching, to the nodes of the systolic array, the updated buffer descriptor concurrently with the nodes executing the previously dispatched packet using a previously stored buffer descriptor.

5. The method of claim 1, further comprising:
reconfiguring the systolic array based on the reconfiguration instructions concurrently with the processing unit executing the previously dispatched packet.

6. The method of claim 5, further comprising:
dispatching instructions from the packet in response to receiving an acknowledgment indicating that the reconfiguration and execution of the previously dispatched packet is complete.

7. An apparatus comprising:
at least one processing unit;
at least one systolic array comprising a plurality of nodes; and
a command processor configured to receive packets comprising instructions for execution on the at least one processing unit or the at least one systolic array and to dispatch the instructions to the at least one processing unit or the at least one systolic array, wherein the command processor is configured to dispatch reconfiguration instructions to reconfigure the at least one systolic array concurrently with the at least one processing unit executing a previously dispatched packet in response to determining that a reconfiguration of the systolic array is to be used to process the instructions and in response to no conflict between the reconfiguration and a current configuration of the systolic array used by the previously dispatched packet that is executing on the systolic array.

8. The apparatus of claim 7, wherein the command processor is configured to inspect a packet to determine whether the reconfiguration of the at least one systolic array is to be performed to process the instructions in the packet.

9. The apparatus of claim 8, wherein the command processor is configured to determine whether a previously dispatched packet is executing on the at least one systolic array in response to determining that reconfiguration of the at least one systolic array is to be performed to process the instructions in the packet.

10. The apparatus of claim 9, wherein the command processor is configured to determine whether a previously dispatched packet is executing on the at least one systolic array in response to determining that reconfiguration of the at least one systolic array is to be performed to process the instructions.

11. The apparatus of claim 7, wherein the command processor is configured to wait for an acknowledgment from the at least one systolic array indicating that execution of the previously dispatched packet on the systolic array is complete and wherein the command processor is configured to dispatch the reconfiguration instructions for execution on the at least one systolic array in response to receiving the acknowledgment.

12. The apparatus of claim 7, wherein the command processor is configured to dispatch information indicating at least one of an updated kernel for execution on nodes of the at least one systolic array, an updated stream switch configuration indicating routing of packets between the nodes of the at least one systolic array, and an updated buffer descriptor indicating a memory location, a stride, or a block size of information stored in a memory.

13. The apparatus of claim 12, wherein the nodes of the systolic array are configured to store pluralities of buffer descriptors, and the apparatus further comprising:
at least one management processor for the at least one systolic array, the at least one management processor being configured to fetch the updated buffer descriptor to the nodes of the at least one systolic array concurrently with the nodes executing the previously dispatched packet using a previously stored buffer descriptor.

14. The apparatus of claim 13, wherein the at least one management processor is configured to reconfigure the at least one systolic array based on the reconfiguration instructions concurrently with the at least one processing unit executing the previously dispatched packet.

15. The apparatus of claim 14, wherein the command processor is configured to dispatch instructions from the packets to the at least one management processor in response to receiving an acknowledgment indicating that the reconfiguration and execution of the previously dispatched packets are complete.

16. A method comprising:
determining that nodes of a systolic array are to be reconfigured to execute at least one first instruction; and
selectively reconfiguring the nodes of the systolic array concurrently with execution of at least one second instruction on a processing unit based on whether at least one third instruction is executing on the systolic array.

17. The method of claim 16, wherein selectively reconfiguring the nodes comprises reconfiguring the nodes concurrently with execution of the at least one second instruction on the processing unit in response to determining that there is no conflict between the reconfiguration and a current configuration used by the at least one third instruction.

18. The method of claim 16, wherein selectively reconfiguring the nodes comprises reconfiguring the nodes in response to receiving acknowledgement that execution of the at least one third instruction on the systolic array is complete.

19. The method of claim 16, wherein selectively reconfiguring the nodes of the systolic array comprises dispatching information indicating at least one of an updated kernel for execution on the nodes of the systolic array, an updated stream switch configuration indicating routing of packets between the nodes of the systolic array, or an updated buffer descriptor indicating a memory location, a stride, or a block size of information stored in a memory.

20. The method of claim 19, wherein the nodes of the systolic array are configured to store pluralities of buffer descriptors, and the method further comprising:
fetching, to the nodes of the systolic array, the updated buffer descriptor concurrently with the nodes executing the at least one third instruction using a previously stored buffer descriptor.
